(19) United States
(12) Patent Application Publication
(10) Pub. No.: US 2025/0322261 A1
(43) Pub. Date: Oct. 16, 2025

(54) METHOD FOR GENERATING LARGE LANGUAGE MODEL, ELECTRONIC DEVICE AND STORAGE MEDIUM

(71) Applicant: Beijing Baidu Netcom Science Technology Co., Ltd., Beijing (CN)

(72) Inventors: Xinsen Zhang, Beijing (CN); Xue Xiong, Beijing (CN); Ayong Zheng, Beijing (CN); Penghao Zhao, Beijing (CN); Jingnan Gu, Beijing (CN)

(73) Assignee: Beijing Baidu Netcom Science Technology Co., Ltd., Beijing (CN)

(21) Appl. No.: 19/249,273

(22) Filed: Jun. 25, 2025

(30) Foreign Application Priority Data
Apr. 1, 2025 (CN) 202510402633.3

(51) Int. Cl. G06N 3/0985; G06N 3/0475

(52) U.S. Cl. CPC G06N 3/0985; G06N 3/0475

(57) ABSTRACT

A method for training a large language model, a method for generating a large language model, an electronic device and a storage medium are provided, relating to the fields of large language model, model training, text processing and other technologies. The method for training a large language model includes: training an initial model according to first training data to obtain a first model; wherein the first training data comprises a first type of text; training the initial model according to second training data to obtain a second model; wherein the second training data comprises the first type of text and a second type of text; and performing parameter fusion according to the first model and the second model to obtain the trained large language model.

### CROSS-REFERENCE TO RELATED APPLICATIONS

The present application claims priority to Chinese Patent Application No. CN202510402633.3, filed with the China National Intellectual Property Administration on Apr. 1, 2025, the disclosure of which is hereby incorporated herein by reference in its entirety.

### TECHNICAL FIELD

The present disclosure relates to the field of artificial intelligence technology, and in particular to the fields of large language model, model training, text processing and other technologies.

### BACKGROUND

The long text abilities of models include abilities to process, analyze and generate longer texts. A large language model (abbreviated as large language model) can capture the context information in the long text, understand the semantics and logical relationship of the text, etc. A method for training the long text of the large language model may include: using a large amount of long text for pre-training based on a short text model, and then fine-tuning multiple times using short text, long-short text, etc. This training method has a complex process and needs to consume huge computing resources.

### SUMMARY

The present disclosure provides a method and an apparatus for generating a large language model, a device and a storage medium.

According to one aspect of the present disclosure, provided is a method for training a large language model, including:
training an initial model according to first training data to obtain a first model; where the first training data includes a first type of text;
training the initial model according to second training data to obtain a second model; where the second training data includes the first type of text and a second type of text; and
performing parameter fusion according to the first model and the second model to obtain the trained large language model.

According to another aspect of the present disclosure, provided is a method for generating a large language model, including:
inputting a text to be processed into the large language model to output a generated result; where the large language model is obtained by training according to the method for training the large language model described above.

According to another aspect of the present disclosure, provided is an apparatus for training a large language model, including:
a first training module configured to train an initial model according to first training data to obtain a first model; where the first training data includes a first type of text;
a second training module configured to train the initial model according to second training data to obtain a second model; where the second training data includes the first type of text and a second type of text; and
a fusion module configured to perform parameter fusion according to the first model and the second model to obtain the trained large language model.

According to another aspect of the present disclosure, provided is an apparatus for generating a large language model, including:
a generation module configured to input a text to be processed into the large language model to output a generated result; where the large language model is obtained by training according to the method for training the large language model in any embodiment of the present disclosure.

According to yet another aspect of the present disclosure, provided is an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

According to yet another aspect of the present disclosure, provided is a non-transitory computer-readable storage medium storing a computer instruction thereon, and the computer instruction is used to cause a computer to execute the method according to any one of the embodiments of the present disclosure.

According to yet another aspect of the present disclosure, provided is a computer program product including a computer program, and the computer program implements the method according to any one of the embodiments of the present disclosure, when executed by a processor.

According to yet another aspect of the present disclosure, provided is a large language model, and the large language model is obtained by training according to the method for training the large language model described above and is used to implement the method for generating the large language model described above.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic flow chart of a method for training a large language model according to an embodiment of the present disclosure;

FIG. 2 is a schematic flow chart of a method for generating a large language model according to an embodiment of the present disclosure;

FIG. 3 is a schematic flow chart of a method for fusing a short text model with a long text model according to an embodiment of the present disclosure;

FIG. 4 is a structural schematic diagram of an apparatus for training a large language model according to an embodiment of the present disclosure;

FIG. 5 is a structural schematic diagram of an apparatus for training a large language model according to another embodiment of the present disclosure;

FIG. 6 is a structural schematic diagram of an apparatus for generating a large language model according to an embodiment of the present disclosure; and

FIG. 7 is a block diagram of an electronic device for implementing the embodiments of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

An example of a method for training a long text of a large language model may include the following steps:
1. Obtaining a base short text model (Base Model): this is a short window model, for example, the window of the model has a context length of 4k or 8k.
2. Long Context Continue Pretraining: further pre-training the Base Model, and using a large amount of data such as 500 million to 10 billion tokens for training on a larger context length such as 32k or 128k to obtain a basic long text ability.
3. General short instruction fine-tuning (Short SFT): using a general short text instruction dataset to further fine-tune the model so that the model has the ability to follow general instructions.
4. Mixed fine-tuning of long and short instruction data (Short-Long Mix SFT): combining short-text and long-text task instruction datasets for mixed fine-tuning to improve the model's ability to follow instructions in terms of long-text tasks.

However, there are some problems in the method for extending the long text ability of the large language model:
1. Complex training process and high cost: the complex training process involves multiple stages, and each stage requires a large amount of computing resources and multiple rounds of training, so that the overall training cost is high and it is difficult to meet the requirements of scenarios with limited computing power.
2. Difficulty in obtaining high-quality long text data: generally, it is difficult to obtain the high-quality long text data (Low-SFT) exceeding 32k, it is difficult to ensure consistency and high quality under large-scale data volumes, and model training often relies on the medium/low-quality data.
3. Poor balance between long and short text abilities: although the long text task ability can be improved after mixed training of the medium/low-quality long text data and the high-quality short text data, but the short text task performance is often decreased significantly, making it difficult to meet the requirements of different task scenarios at the same time.
4. Insufficient strategy universality: the general scalability of the long text training strategy is poor. The lack of universality and scalability further increases the trial-and-error costs of development and deployment.

The embodiments of the present disclosure can improve the long text training of large models in one or more aspects such as data quality, computing power cost, ability balance and universality.

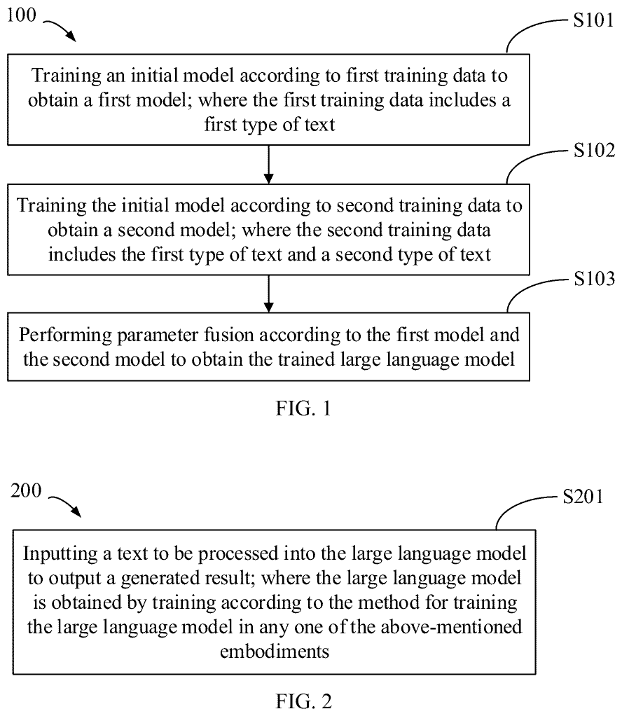

FIG. 1 is a schematic flow chart of a method 100 for training a large language model according to an embodiment of the present disclosure. In one implementation, the method may include:
S101: training an initial model according to first training data to obtain a first model; where the first training data includes a first type of text;
S102: training the initial model according to second training data to obtain a second model; where the second training data includes the first type of text and a second type of text; and
S103: performing parameter fusion according to the first model and the second model to obtain the trained large language model.

In the embodiment of the present disclosure, the initial model may include a basic short text model (Base Model), such as a short window model with a context length of 4k or 8k. The initial model may have some general instruction processing abilities.

In the embodiment of the present disclosure, the first training data may include a plurality of first type of texts. The first type of text may include a text instruction. Taking the first type of text as a short text instruction as an example, the first type of text may include a question-answer pair, that is, a question part and an answer part. The question part of the first type of text in the first training data may be input into the initial model to obtain an output result. The initial model may be fine-tuned based on the answer part of the first type of text and the output result, etc., to obtain the first model that can process the first type of text such as short text instruction. A fine-tuning method may include: calculating a loss function based on the answer part and the output result. If the loss function does not converge, the first training data continues to be used for training after the parameters of the initial model are fine-tuned. The first type of text included in the first training data used each time may be the same or different. If the loss function converges, the training may be stopped to obtain the trained first model. If the initial model is trained using the short text instruction, it is possible to adapt to the semantic compression and rapid response requirement of short texts, and optimize the model's ability to understand and generate short texts, such as sentiment analysis, keyword extraction, etc.

In the embodiment of the present disclosure, the second training data may include a plurality of first type of texts and a plurality of second type of texts. That is to say, the second training data is mixed data of different types of texts. The first type of text in the second training data may be the same as that in the first training data. The second type of text may include a text instruction. Taking the second type of text as a long text instruction as an example, the second type of text may include text content such as novels, news or papers, and annotation content corresponding thereto. The question part of the first type of text and the text content of the second type of text in the second training data may be input into the initial model to obtain an output result. The initial model may be fine-tuned based on the answer part of the first type of text, the annotation content of the second type of text and the output result, etc., to obtain the second model that can process the second type of text such as long text instruction. The fine-tuning method can refer to the above description related to the loss function of the first model. If the initial model is trained with mixed long and short text instructions, the large language model (referred to as large model) can learn long text abilities, such as the ability to process long texts, the ability to generate long texts, the ability to semantically condense long texts, the ability to jointly process complex contexts and multi-scale texts, etc.

In the embodiment of the present disclosure, the initial model trained using the first training data and the initial model trained using the second training data may be the same model. Before training, the initial models may have the same structure and parameter values. After training, the first model and the second model have the same structure but different parameter values. The parameters of each layer of the first model and the second model may be fused layer by layer, or specific parameters of the first model and the second model may be fused, to obtain new parameters. The parameter fusion may include a method of combining parameters of two models according to a specific rule, such as weighted averaging, layer-by-layer interpolation, etc., which is not limited in the present disclosure. The weights of a new model may be generated through parameter fusion to inherit the advantageous features of different models. For example, the weighted fusion may be performed on the parameters of corresponding layers of the first model and the second model according to a weight of, for example, 0.3:0.7, to obtain a large language model.

According to the embodiment of the present disclosure, the large language model obtained by training can take into account both efficiency and applicability in multiple scenarios through phased training and parameter fusion, thereby improving the ability of the large language model to process more types of texts. For example, the gradient conflict during mixed data training can be avoided through phased training, the response efficiency of the large language model can be optimized through the first training data, and the context processing length of the large language model can be expanded through the second training data. The advantages of the two models can be combined through parameter fusion, to reduce the performance degradation caused by continued mixed training.

In one implementation, a length of the first type of text is less than a length of the second type of text; the first model is a short text model; and the second model is a long text model. In the embodiment of the present disclosure, the first type of text may include a short text instruction. The short text instruction may include a text segment with a short length and high information density, such as a text segment with a single topic or simple semantics, for example, a social media comment, a news headline, a question-answer pair, etc. The second type of text may include a long text instruction. The long text instruction may include a paragraph, a chapter, a book, etc., and have complex logic and contextual association. The length of the first type of text may be much less than the length of the second type of text. The number of first type of texts may be much greater than the number of second type of texts. The quality of the first type of text may be higher than the quality of the second type of text. For example, the first type of text includes 200,000 pieces of general short text Supervised Fine-Tuning (SFT) data with high quality. The second type of text includes 20,000 pieces of mixed long and short SFT data with medium and/or low quality.

In the embodiment of the present disclosure, a short text model with the ability to follow short text instructions may be obtained by training the initial model using the short text instruction with high quality, a long text model with the ability to follow long context instructions may be obtained by training the initial model using the mixed text of the short text instruction with high quality and the long text instruction with medium/low quality, and the trained large language model may be obtained by performing parameter fusion according to the short text model and the long text model.

According to the embodiment of the present disclosure, the short text model and the long text model may be obtained by training the same model using different training data, and thus the fused large language model has stronger long and short text abilities.

In one implementation, a length of the second type of text is longer than a window length of the initial model; and the window length of the initial model is a maximum text length that the initial model is able to process at one time.

In the embodiment of the present disclosure, in order to expand the ability of the large language model to process texts with different lengths and enhance the ability of the large language model to process texts longer than the window length, the second type of text with the length longer than the window of the large language model may be added to the training data. For example, the window length of the initial model is L, and the window length range of the final enhanced long text model may reach 4L to 32L (4 to 32 times the initial window) depending on the computing power, for example, expanding from a window of 4096 to a length of 32768 or 131072.

According to the embodiment of the present disclosure, the initial large language model is fine-tuned using the mixed data of the first type of text and the second type of text, and the maximum text length that the obtained second model can process at one time is improved compared to the initial model, helping to enhance the ability of the large language model to process texts with different lengths, especially long texts.

In one implementation, the first model includes a first parameter, and the second model includes a second parameter; and S103 of performing parameter fusion according to the first model and the second model to obtain the trained large language model further includes: obtaining the large language model according to the first parameter, the second parameter and a fusion coefficient.

In the embodiment of the present disclosure, the parameter in the first model may be referred to as the first parameter, and the parameter in the second model may be referred to as the second parameter. The fusion coefficient of the first parameter and the second parameter may be set according to requirements. The fusion coefficient may also be called fusion weight, fusion ratio, etc. The fusion coefficient may indicate the importance of the parameters of different models in the parameters of the final fused large language model. The fusion coefficient may be a numerical value, a vector or a matrix, and may be determined based on the structure, parameter type, etc. of the initial model. For example, the fusion coefficient corresponding to all first parameters in the first model is 0.4, and the fusion coefficient corresponding to all second parameters in the second model is 0.6. For another example, in the first model, the fusion coefficient corresponding to the first parameter of the first layer is a, the fusion coefficient corresponding to the first parameter of the second layer is b, and the fusion coefficient corresponding to the first parameters of other layers is c; and in the second model, the fusion coefficient corresponding to the second parameter of the first layer is 1-a, the fusion coefficient corresponding to the second parameter of the second layer is 1-b, and the fusion coefficient corresponding to the second parameters of other layers is 1-c. In this example, the fusion coefficients of the first model and the second model may be represented by vectors. For another example, if different parameters of different layers of the model may be fused using different values, the fusion coefficients may also be represented by a matrix related to the parameters of the model.

In the embodiment of the present disclosure, the ability of the final large language model to process different types of texts can be adjusted by adjusting the fusion coefficients, so that the large language model focuses on different functions. For example, the large language model having the ability to follow both short text instructions and long text instructions can be obtained by adjusting the fusion coefficients of the short text model and the long text model.

According to the embodiment of the present disclosure, the ability of the large language model to process various types of texts, such as long and short texts, can be optimized by fusing the parameters of different models using fusion coefficients, thereby improving the flexibility and universality of the large language model, and reducing the difficulty in training the large language model.

In one implementation, the step of obtaining the large language model according to the first parameter, the second parameter and the fusion coefficient includes:
calculating a weighted sum according to the first parameter, a first fusion coefficient, the second parameter and a second fusion coefficient to obtain the large language model; where the first fusion coefficient represents a proportion of the first model in the large language model; and the second fusion coefficient represents a proportion of the second model in the large language model.

In the embodiment of the present disclosure, the first fusion coefficient may be used as the weight of the first parameter, and the second fusion coefficient may be used as the weight of the second parameter. An example of a calculation method for parameter fusion is as follows:

Θ_{merged}=λₛₕₒᵣₜΘₛₕₒᵣₜ+λ_{long}Θ_{long}

Here, Θₛₕₒᵣₜ and Θ_{long} represent the parameters of the first model and the second model respectively, and λₛₕₒᵣₜ and λ_{long} are the fusion coefficients of the two models and represent the proportions of the two models. The fused parameter Θ_{merged} is used as the parameter of the final large language model.

According to the embodiment of the present disclosure, the large language model with the good ability to process various texts, such as long and short texts, can be obtained through weighted fusion calculation, which can not only improve the applicability of the large language model, but also enhance the flexibility of the large language model.

FIG. 2 is a schematic flow chart of a method 200 for generating a large language model according to an embodiment of the present disclosure. In one implementation, the method may include:

S201: inputting a text to be processed into the large language model to output a generated result; where the large language model is obtained by training according to the method for training the large language model in any one of the above-mentioned embodiments.

In the embodiment of the present disclosure, the text to be processed may be directly input into the large language model without preprocessing. A plurality of texts may be merged and input as the text to be processed into the large language model.

In the embodiment of the present disclosure, the use of the trained large language model can implement functions such as long text classification, long information retrieval, sentiment analysis, text analysis, summary generation, image generation, video generation, audio generation, dialogue and others according to the input text to be processed.

According to the embodiment of the present disclosure, corresponding processing can be performed based on the input text to be processed to obtain the expected result.

In one implementation, the text to be processed includes a first type of text and/or a second type of text.

In the embodiment of the present disclosure, explanations and examples of the first type of text and/or the second type of text may refer to the relevant description in the above-mentioned training method, and will not be repeated here.

According to the embodiment of the present disclosure, the model can process different types of texts to be processed and has the relatively strong flexibility and applicability.

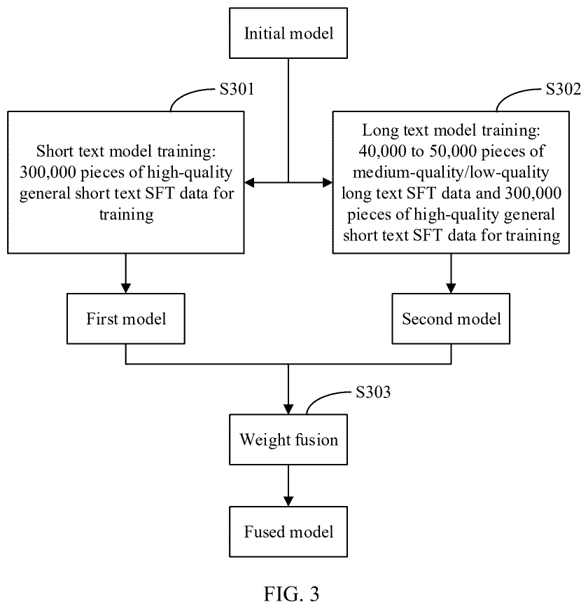

FIG. 3 shows a method for fusing a short text model with a long text model according to an embodiment of the present disclosure. As shown in FIG. 3, the method may efficiently expand the long text ability of the model based on model fusion. The method may include the following steps:
S301: short text model training: use a first quantity, for example, 300,000 pieces of high-quality general short text SFT data (labeled as Short-SFT data) for training to obtain a first model. The first model has the ability to follow general instructions.
S302: long text model training: use a second quantity, for example, 40,000 to 50,000 pieces of medium-quality/low-quality long text SFT data (labeled as Long-SFT data) and 300,000 pieces of high-quality general short text SFT data for mixed training to obtain a second model. The second model may learn to handle tasks of following long-context instructions.
S303: weight fusion: fuse the weights of the two models obtained in steps S301 and S302. An example of a fusion formula is as follows:

Θ_{merged}=λₛₕₒᵣₜΘₛₕₒᵣₜ+λ_{long}Θ_{long}

Here, Θₛₕₒᵣₜ and Θ_{long} represent the weights of the short text model and the long text model respectively, and λₛₕₒᵣₜ and λ_{long} are fusion coefficients and represent proportions of the two models. The fused weight Θ_{merged} is used as the final long text model.

The method of the present disclosure can be applied to process LLM long text tasks. Specific application examples are as follows:
1. Long text classification: The long text model enhanced in the present disclosure can be used to classify the longer content such as novels or news input by users.
2. Long information retrieval: In search engines, the query terms entered by users are usually short texts, while the results returned may be long articles. The long text model enhanced by the algorithm of the present disclosure can optimize the relevance of search results and provide answers meeting user requirements better.
3. Sentiment analysis: In market research, consumers may leave brief comments or detailed feedbacks. The long text model enhanced by the algorithm of the present disclosure can capture the potential sentiment tendencies in long comments while analyzing short comments, thereby providing companies with more comprehensive insights.

By using the efficient method for expanding the long text proposed in the present disclosure, a model with excellent long text ability and short text ability can be obtained after fusion. For example, in one training result, the general short text ability of the short text model is 8.3, the general short text ability of the long text model is 6.94, and the general short text ability of the fused model is 7.81. The general long text ability of the short text model is relatively poor, the general long text ability of the long text model is relatively good, and the general long text ability of the fused model is close to that of the long text model, for example, can process 128k of content.

The present disclosure can use lower-quality Long-SFT linguistic data to supervise and fine-tune the short text model without large-scale long text continue pretraining of the original short-window context model, and then merge it with the better short text model to finally obtain a large language model with the better ability to process long and short text tasks. This method is suitable for application scenarios that require efficient expansion of the model's long text ability. Especially in scenarios where the computing power is limited and the high-quality data annotation is limited, the ability to process long text tasks can be better expanded with lower computing resources and lower data quality.

The application scenarios of the present disclosure include but are not limited to: expanding the long text ability of the large language model: long conversation, long text retrieval summary, and other tasks.

The present disclosure can achieve efficient expansion of the model's ability to process long text tasks with lower computing resources and lower data quality while maximizing the performance of existing short text models, reduce the overall system cost, and improve the practicality and scalability.

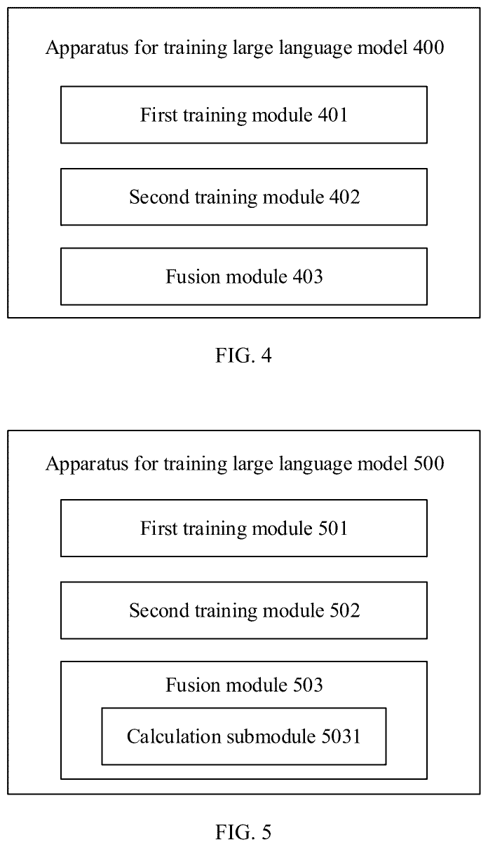

FIG. 4 is a structural schematic diagram of an apparatus 400 for training a large language model according to an embodiment of the present disclosure. In one implementation, the apparatus may include:
a first training module 401 configured to train an initial model according to first training data to obtain a first model; where the first training data includes a first type of text;
a second training module 402 configured to train the initial model according to second training data to obtain a second model; where the second training data includes the first type of text and a second type of text; and
a fusion module 403 configured to perform parameter fusion according to the first model and the second model to obtain the trained large language model.

In one implementation, a length of the first type of text is less than a length of the second type of text; the first model is a short text model; and the second model is a long text model.

In one implementation, a length of the second type of text is longer than a window length of the initial model; and the window length of the initial model is a maximum text length that the initial model is able to process at one time.

FIG. 5 is a structural schematic diagram of an apparatus 500 for training a large language model according to another embodiment of the present disclosure. The apparatus 500 may include: a first training module 501, a second training module 502 and a fusion module 503. The functions of the above modules can refer to the functions of the modules of the apparatus 400 for training the large language model in the above embodiment. In one implementation, the first model includes a first parameter, and the second model includes a second parameter; and the fusion module 503 includes:
a calculation submodule 5031 configured to obtain the large language model according to the first parameter, the second parameter and a fusion coefficient.

In one implementation, the calculation submodule 5031 is further configured to calculate a weighted sum according to the first parameter, a first fusion coefficient, the second parameter and a second fusion coefficient to obtain the large language model; where the first fusion coefficient represents a proportion of the first model in the large language model; and the second fusion coefficient represents a proportion of the second model in the large language model.

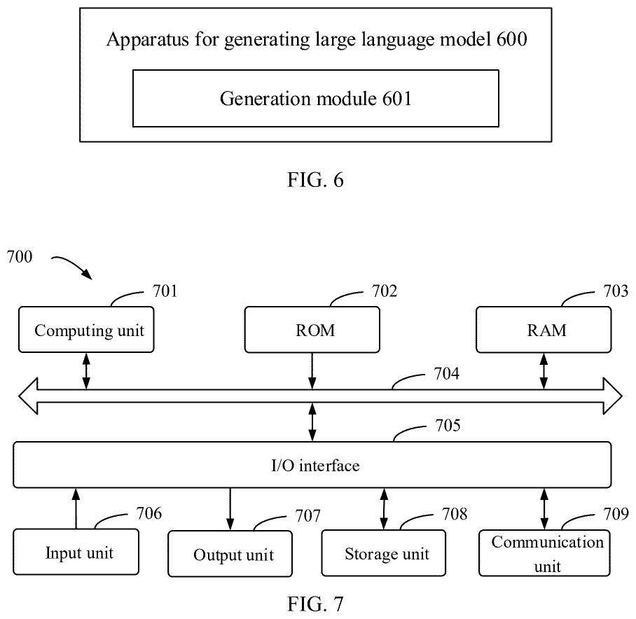

FIG. 6 is a structural schematic diagram of an apparatus 600 for generating a large language model according to an embodiment of the present disclosure. In one implementation, the apparatus may include:
a generation module 601 configured to input a text to be processed into the large language model to output a generated result; where the large language model is obtained by training according to any apparatus for training the large language model in the above embodiments.

In one implementation, the text to be processed includes a first type of text and/or a second type of text.

For the description of specific functions and examples of the modules and sub-modules of the apparatus of the embodiment of the present disclosure, reference may be made to the relevant description of the corresponding steps in the above-mentioned method embodiments, and details are not repeated here.

In the technical solution of the present disclosure, the acquisition, storage and application of the user's personal information involved are in compliance with relevant laws and regulations, and do not violate public order and good customs.

According to the embodiments of the present disclosure, the present disclosure also provides an electronic device, a readable storage medium and a computer program product.

FIG. 7 shows a schematic block diagram of an exemplary electronic device 700 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 7, the device 700 includes a computing unit 701 that may perform various appropriate actions and processes according to a computer program stored in a Read-Only Memory (ROM) 702 or a computer program loaded from a storage unit 708 into a Random Access Memory (RAM) 703. Various programs and data required for an operation of device 700 may also be stored in the RAM 703. The computing unit 701, the ROM 702 and the RAM 703 are connected to each other through a bus 704. The input/output (I/O) interface 705 is also connected to the bus 704.

A plurality of components in the device 700 are connected to the I/O interface 705, and include an input unit 706 such as a keyboard, a mouse, or the like; an output unit 707 such as various types of displays, speakers, or the like; the storage unit 708 such as a magnetic disk, an optical disk, or the like; and a communication unit 709 such as a network card, a modem, a wireless communication transceiver, or the like. The communication unit 709 allows the device 700 to exchange information/data with other devices through a computer network such as the Internet and/or various telecommunication networks.

The computing unit 701 may be various general-purpose and/or special-purpose processing components with processing and computing capabilities. Some examples of the computing unit 701 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 701 performs various methods and processes described above, such as the method for training the large language model and/or the method for generating the large language model. For example, in some implementations, the method for training the large language model and/or the method for generating the large language model may be implemented as a computer software program tangibly contained in a computer-readable medium, such as the storage unit 708. In some implementations, a part or all of the computer program may be loaded and/or installed on the device 700 via the ROM 702 and/or the communication unit 709. When the computer program is loaded into the RAM 703 and executed by the computing unit 701, one or more steps of the method for training the large language model and/or the method for generating the large language model described above may be performed. Alternatively, in other implementations, the computing unit 701 may be configured to perform the method for training the large language model and/or the method for generating the large language model by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for training a large language model, comprising:
training an initial model according to first training data to obtain a first model; wherein the first training data comprises a first type of text;
training the initial model according to second training data to obtain a second model; wherein the second training data comprises the first type of text and a second type of text; and
performing parameter fusion according to the first model and the second model to obtain the trained large language model.

2. The method of claim 1, wherein a length of the first type of text is less than a length of the second type of text; the first model is a short text model; and the second model is a long text model.

3. The method of claim 1, wherein a length of the second type of text is longer than a window length of the initial model; and the window length of the initial model is a maximum text length that the initial model is able to process at one time.

4. The method of claim 1, wherein the first model comprises a first parameter, and the second model comprises a second parameter; and the performing parameter fusion according to the first model and the second model to obtain the trained large language model, comprises:
obtaining the large language model according to the first parameter, the second parameter and a fusion coefficient.

5. The method of claim 4, wherein obtaining the large language model according to the first parameter, the second parameter and a fusion coefficient, comprises:
calculating a weighted sum according to the first parameter, a first fusion coefficient, the second parameter and a second fusion coefficient to obtain the large language model; wherein the first fusion coefficient represents a proportion of the first model in the large language model; and the second fusion coefficient represents a proportion of the second model in the large language model.

6. A method for generating a large language model, comprising:
inputting a text to be processed into the large language model to output a generated result; wherein the large language model is obtained by training according to the method for training the large language model of claim 1.

7. The method of claim 6, wherein the text to be processed comprises a first type of text and/or a second type of text.

8. An electronic device, comprising:
at least one processor; and
a memory connected in communication with the at least one processor;
wherein the memory stores an instruction executable by the at least one processor, and the instruction, when executed by the at least one processor, enables the at least one processor to execute:
training an initial model according to first training data to obtain a first model; wherein the first training data comprises a first type of text;
training the initial model according to second training data to obtain a second model; wherein the second training data comprises the first type of text and a second type of text; and
performing parameter fusion according to the first model and the second model to obtain the trained large language model.

9. The electronic device of claim 8, wherein a length of the first type of text is less than a length of the second type of text; the first model is a short text model; and the second model is a long text model.

10. The electronic device of claim 8, wherein a length of the second type of text is longer than a window length of the initial model; and the window length of the initial model is a maximum text length that the initial model is able to process at one time.

11. The electronic device of claim 8, wherein the first model comprises a first parameter, and the second model comprises a second parameter; and
the instruction, when executed by the at least one processor, enables the at least one processor to execute performing parameter fusion according to the first model and the second model to obtain the trained large language model, by:
obtaining the large language model according to the first parameter, the second parameter and a fusion coefficient.

12. The electronic device of claim 11, wherein the instruction, when executed by the at least one processor, enables the at least one processor to execute obtaining the large language model according to the first parameter, the second parameter and a fusion coefficient, by:
calculating a weighted sum according to the first parameter, a first fusion coefficient, the second parameter and a second fusion coefficient to obtain the large language model; wherein the first fusion coefficient represents a proportion of the first model in the large language model; and the second fusion coefficient represents a proportion of the second model in the large language model.

13. An electronic device, comprising:
at least one processor; and
a memory connected in communication with the at least one processor;
wherein the memory stores an instruction executable by the at least one processor, and the instruction, when executed by the at least one processor, enables the at least one processor to execute the method of claim 6.

14. The electronic device of claim 13, wherein the text to be processed comprises a first type of text and/or a second type of text.

15. A non-transitory computer-readable storage medium storing a computer instruction thereon, wherein the computer instruction is used to cause a computer to execute the method of claim 1.

16. The non-transitory computer-readable storage medium of claim 15, wherein a length of the first type of text is less than a length of the second type of text; the first model is a short text model; and the second model is a long text model.

17. The non-transitory computer-readable storage medium of claim 15, wherein a length of the second type of text is longer than a window length of the initial model; and the window length of the initial model is a maximum text length that the initial model is able to process at one time.

18. The non-transitory computer-readable storage medium of claim 15, wherein the first model comprises a first parameter, and the second model comprises a second parameter; and
the computer instruction is used to cause a computer to execute performing parameter fusion according to the first model and the second model to obtain the trained large language model, by:
obtaining the large language model according to the first parameter, the second parameter and a fusion coefficient.

19. A non-transitory computer-readable storage medium storing a computer instruction thereon, wherein the computer instruction is used to cause a computer to execute the method of claim 6.

20. The non-transitory computer-readable storage medium of claim 19, wherein the text to be processed comprises a first type of text and/or a second type of text.
